(19) United States
(12) Patent Application Publication
(10) Pub. No.: US 2020/0281222 A1
(43) Pub. Date: Sep. 10, 2020

(54) CHEWING GUM COMPOSITION USING HERICIUM ERINACEUS EXTRACT AND CORDYCEPIN, AND PREPARATION METHOD THEREFOR

(71) Applicants: Dae-Hee LEE, Cheongju-si Chungebeongbuk-do (KR); CNG BIO CO., LTD., Cheongju-si, Chungcheongbuk-do (KR)

(72) Inventors: Dae-Hee LEE, Cheongju-si (KR); Seon-Ho KIM, Seoul (KR); Dong-Woo LEE, Daejeon (KR)

(21) Appl. No.: 15/781,009

(22) PCT Filed: Dec. 1, 2016
(86) PCT No.: PCT/KR2016/014066

§ 371 Date: Jun. 1, 2018

(30) Foreign Application Priority Data
Dec. 1, 2015 (KR) 10-2015-0169831

(51) Int. Cl. A23G 4/06; A23G 4/10

(52) U.S. Cl. CPC A23G 4/068; A23G 4/10

(57) ABSTRACT

The present invention relates to a chewing gum composition containing a gum base and a Hericium erinaceus extract. In addition, the present invention relates to a chewing gum composition containing a gum base, a Hericium erinaceus extract and cordycepin. The chewing gum composition according to the present invention has a salivation secretion promoting effect, a bad breath inhibitory effect, and an antibacterial effect.

### TECHNICAL FIELD

The present invention relates to a chewing gum composition comprising a Hericium erinaceus extract and cordycepin, and a preparation method thereof.

### BACKGROUND ART

Gum, i.e., chewing gum, is a kind of food in which additives such as flavorings and softeners etc. are added into a gum base. We chew it and enjoy its flavor and texture.

Various types of chewing gums having different flavors depending on types of flavors and additives to be added to the gum base have been developed. Recently, functional chewing gums made by adding functional ingredients to chewing gum have been developed. For example, Korean patent application no. 10-2011-0011350 discloses chewing gum for preventing and improving a periodontal disease, and Korean patent no. 10-1138851 discloses nonsmoking gum.

Hericium erinaceus has more kinds of active polysaccharides in comparison to ordinary mushrooms. In particular, Hericium erinaceus contains special active polysaccharides such as, galactoxyloglucan and mannoglucoxylane, and thus has excellent anticancer activity.

In addition, it was found that Hericium polysaccharide known to be contained only in Hericium erinaceus acts to enhance macrophages or lymphocytes by attacking bacteria, viruses or defective cells, thereby preventing the development of colorectal cancer or gastric cancer, and is also effective against various gastritis diseases.

It is known that Hericium erinaceus contains a large amount of oleanolic acid which is contained only in some medicinal mushrooms, and thus it protects the stomach wall and is effective against gastric ulcer and gastritis.

In particular, it was found that Hericium erinaceus contains herisenone D and erinacine C to promote the biosynthesis of nerve growth factor. It is known that the nerve growth factor has an excellent effect on the prevention and treatment of senile dementia.

In addition, herisenone D and erinacine C contained in Hericium erinaceus are delivered to the brain through blood to promote the synthesis of nerve growth factor, thereby providing an effective treatment method.

Moreover, herisenone D and erinacine C have nerve growth factor-stimulating activity four times higher than the hormone epinephrine in the brain, and thus prevent the loss of neurons and stimulate the synthesis of neurons. In this regard, it can be considered that herisenone D and erinacine C play a great role in the development of intelligence of children in a growth phase or teenagers.

In particular, minerals such as, for example, potassium, calcium, magnesium, etc., contained in Hericium erinaceus, enter the body and interact with enzymes and release ionized metabolic signals. According to these signals, low-molecular-weight substances such as, for example, peptides are absorbed into cells to restore a function of beta cells and promote insulin secretion. In other words, it is known that, through such a series of actions, insulin is normally secreted and blood glucose levels are lowered to alleviate diabetes, and a liver function is also improved.

Cordycepin, a natural antibiotic derived from Cordyceps, has been emerged as an immune enhancing component. In particular, cordycepin has been recently shown to have antiviral efficacy.

The present inventors have studied gum which promotes saliva secretion by chewing gum in view of the fact that a dried mouth resulting from lack of saliva in oral cavity is a direct or indirect cause of bad breath and tooth decay. During the study, the present inventors have found that chewing gum made by adding Hericium erinaceus and cordycepin to the gum base promotes saliva secretion, and completed the present invention based on this finding.

### DISCLOSURE

### Technical Problem

It is an object of the present invention to provide a chewing gum composition for promoting saliva secretion.

### Technical Solution

According to an aspect of the present invention, there is provided a chewing gum composition containing a gum base and a Hericium erinaceus extract.

According to another aspect of the present invention, there is provided a method for preparing a chewing gum composition, the method including preparing a gum base; adding a Hericium erinaceus extract to the gum base to produce a mixture; and, forming the mixture in a shape of chewing gum

### Advantageous Effects

According to the present invention, the chewing gum composition has a salivation promoting effect, and a bad breath removal and inhibitory effect. Further, the chewing gum composition has an effect of preventing and inhibiting tooth decay by increasing saliva secretion. Furthermore, the chewing gum composition is an antibacterial chewing gum composition.

### BEST MODE

The present invention relates to a chewing gum composition containing a gum base and a Hericium erinaceus extract.

Further, the present invention relates to a method for preparing a chewing gum composition, the method including preparing a gum base, adding a Hericium erinaceus extract to the gum base to produce a mixture, and, forming the mixture in a shape of chewing gum.

Hereinafter, the present invention will be described in detail.

Gum Base

The gum base according to the present invention, which is a general gum base, may be obtained by purchasing a commercially available gum base or by ordering it from a manufacturer. Normal chewing gums are prepared by adding particular ingredients to the gum base, and therefore, those skilled in the art would appropriately select the gum base.

Hericium erinaceus Extract

The Hericium erinaceus extract is an extract of a Hericium erinaceus fruiting body, a Hericium erinaceus mycelium, or Hericium erinaceus fruiting body and mycelium. The extract is preferably an extract of water or a low-alcohol having 5 or less carbons, more preferably an extract of water or a low-alcohol having 3 or less carbons, and most preferably an ethanol extract.

At this time, the ethanol extract is preferably an extract extracted with a solvent containing ethanol and water. By adding the Hericium erinaceus extract to the ethanol extract, the chewing gum composition according to the present invention may promote saliva secretion, and have a taste and flavor peculiar to the Hericium erinaceus extract.

The chewing gum composition according to the present invention includes 10 to 60 parts by weight of the Hericium erinaceus extract based on 100 parts by weight of the gum base. When the Hericium erinaceus extract is added in an amount of less than 10 parts by weight, it is difficult to show significant effects of promoting saliva secretion and inhibiting bad breath which are characteristics of the chewing gum composition according to the present invention. In addition, when the Hericium erinaceus extract is added in an amount of 60 parts or more by weight, the taste of the Hericium erinaceus extract becomes too strong. For this reason, it is necessary to add other additives, and there is a feeling of discomfort when chewing the chewing gum composition.

Cordycepin

The chewing gum composition according to the present invention includes 1 to 20 parts by weight of cordycepin based on 100 parts by weight of the gum base. The inclusion of cordycepin allows the chewing gum composition according to the present invention to further have antibacterial activity. The chewing gum composition according to the present invention not only promotes saliva secretion but also has the antimicrobial activity of cordycepin. Thus, the chewing gum composition is beneficial to oral health, and prevents and inhibits tooth decay caused by Streptococcus mutans.

Step of Preparing a Gum Base

The method of preparing a chewing gum composition according to the present invention includes a step of preparing a gum base. The gum base may be obtained by purchasing a commercially available gum base, or by ordering it from a manufacturer. The gum base is a gum base generally used to manufacture chewing gum, but is not particularly limited thereto.

Step of Producing a Mixture

The method of preparing a chewing gum composition according to the present invention includes a step of adding a Hericium erinaceus extract to the gum base to produce a mixture. At this time, it is preferable to further add cordycepin to the gum base together with the Hericium erinaceus extract.

More preferably, the step of producing the mixture is carried out by adding the Hericium erinaceus extract, cordycepin, and other additives to the gum base. The additives are additives generally used to manufacture chewing gum, but are not particularly limited thereto. For example, the additives may be stabilizers, antibacterial ingredients, softeners, taste enhancers, flavorings, sweeteners, colorants, or the like.

Preferably, the step of producing a mixture may be carried out by adding 10 to 60 parts by weight of the Hericium erinaceus extract, 1 to 20 parts by weight of cordycepin, 0.1 to 3 parts by weight of disodium edetate which is a stabilizer, 0.3 to 2 parts by weight of menthol, 0.5 to 3 parts by weight of cetylpyridinium chloride, 0.1 to 1 part by weight of a softener, 5 to 20 parts by weight of a sorbitol solution, 3 to 10 parts by weight of isomaltooligosaccharide, 3 to 10 parts by weight of xylitol, 0.1 to 1 part by weight of a favoring, 0.1 to 1 part by weight of a sweetener, and 0.1 to 1 part by weight of an edible colorant to the gum base.

Step of Forming the Mixture in a Shape of Chewing Gum

The method of preparing a chewing gum composition according to the present invention includes a step of forming the mixture in a shape of chewing gum. At this time, it is possible to use devices such as, for example, a stirrer and an extruder generally used to manufacture gum. The shape of gum may be a generally used shape such as, for example, a flat shape or a round shape, but is not particularly limited thereto.

Method of Promoting Saliva Secretion

The method of promoting saliva secretion includes a step of putting the chewing gum composition according to the present invention into a mouth of a subject and a step of the chewing gum composition being chewed by the subject.

Method of Inhibiting Bad Breath

The method of inhibiting bad breath include a step of putting the chewing gum composition according to the present invention into a mouth of a subject and a step of the chewing gum composition being chewed by the subject.

Subject

The subjects who chew the chewing gum composition according to the present invention are people, in particular, a person who experience a dry mouth often, a person who has bad breath, and elderly people.

Chewing Gum Composition According to the Present Invention

The chewing gum composition according to the present invention is a chewing gum composition containing a gum base and a Hericium erinaceus extract. Preferably, the chewing gum composition according to the present invention is a chewing gum composition containing a gum base, a Hericium erinaceus extract, and cordycepin.

The chewing gum composition according to the present invention is a chewing gum composition for promoting saliva secretion, a chewing gum composition for removing and inhibiting bad breath, and an antibacterial chewing gum composition. The chewing gum composition according to the present invention has a salivation promoting effect after chewing the chewing gum, and a bad breath removal and inhibitory effect. Further, the chewing gum composition has an effect of preventing and inhibiting tooth decay because an increase in saliva secretion and the antibacterial activity of cordycepin suppress propagation of Streptococcus mutans.

In particular, the chewing gum composition according to the present invention has a saliva secretion promoting effect, and thus is useful for oral health of people with dry mouth, especially elderly people. In addition, the chewing gum composition according to the present invention contains a Hericium erinaceus extract, and accordingly has a flavor and taste peculiar to the Hericium erinaceus extract. It is advantageous that elderly people have a high preference for the flavor and taste.

### MODE FOR INVENTION

Advantages and features of the present invention and methods for achieving them will become apparent from the descriptions of embodiments herein below with reference to the accompanying drawings. However, the present invention is not limited to the embodiments disclosed herein but may be implemented in various different forms. The embodiments are provided to make the description of the present invention thorough and to fully convey the scope of the present invention to those skilled in the art. It is to be noted that the scope of the present invention is defined only by the claims.

<Materials and Method>

For the fruiting body and mycelium of Hericium erinaceus, a fruiting body and mycelium of commercially available Korean Hericium erinaceus were purchased and used. For cordycepin, commercially available cordycepin was purchased and used.

For the gum base, a commercially available gum base was purchased and used. The gum base is a commercially available gum base containing 40 parts by weight of polyisobutylene, 20 parts by weight of wax, 5 parts by weight of an emulsifier, 20 parts by weight of talc, 10 parts by weight of calcium carbonate, 3 parts by weight of a plasticizer, 48 parts by weight of ester gum, 5 parts by weight of a natural sweetener, and 4 parts by weight of glycerin based on 100 parts by weight of polyvinylacetate.

### <Preparation Example 1> Preparation of Hericium erinaceus Fruiting Body Powder

10 kg of a Hericium erinaceus fruiting body was washed clean, and then dried in a cylindrical stainless vacuum dryer at a temperature of 40 to 60° C. for 20 hours or more, thereby preparing a dried Hericium erinaceus fruiting body having a water content of 3% or less. The dried Hericium erinaceus fruiting body was pulverized with a pin mill to prepare Hericium erinaceus fruiting body powder having a size of about 50 mesh.

### <Preparation Example 2> Preparation of Hericium erinaceus Mycelium Powder

10 kg of Hericium erinaceus mycelium was washed clean, and then dried in a cylindrical stainless vacuum dryer at a temperature of 40 to 60° C. for 20 hours or more, thereby preparing a dried Hericium erinaceus mycelium having a water content of 3% or less. The dried Hericium erinaceus mycelium was pulverized with a pin mill to prepare Hericium erinaceus mycelium powder having a size of about 50 mesh.

### <Preparation Example 3> Preparation of Hericium erinaceus Extract A

5 kg of the Hericium erinaceus fruiting body powder prepared in Preparation Example 1 was added to a solvent mixture of 2.5 L of ethanol and 10 L of water, and heated in a 100 L stainless container equipped with a reflux apparatus at a temperature of 90 to 98° C. for 24 hours to extract a crude extract. The crude extract was filtered with a nonwoven fabric filter, and then the solvent mixture was evaporated by vacuum distillation, thereby preparing 500 ml of a Hericium erinaceus fruiting body extract in a concentrated liquid form. The Hericium erinaceus fruiting body extract was lyophilized, and the lyophilized Hericium erinaceus fruiting body extract was named Hericium erinaceus extract A. The Hericium erinaceus extract A was used to manufacture chewing gum.

### <Preparation Example 4> Preparation of Hericium erinaceus Extract B

5 kg of the Hericium erinaceus mycelium powder prepared in Preparation Example 2 was added to a solvent mixture of 2.5 L of ethanol and 10 L of water, and heated in a 100 L stainless container equipped with a reflux apparatus at a temperature of 90 to 98° C. for 24 hours to extract a crude extract. The crude extract was filtered with a nonwoven fabric filter, and then the solvent mixture was evaporated by vacuum distillation, thereby preparing 500 ml of a Hericium erinaceus mycelium extract in a concentrated liquid form. The Hericium erinaceus mycelium extract was lyophilized, and the lyophilized Hericium erinaceus mycelium extract was named Hericium erinaceus extract B. The Hericium erinaceus extract B was used to manufacture chewing gum.

### <Preparation Example 5> Preparation of Hericium erinaceus Extract C

3.5 kg of the Hericium erinaceus fruiting body powder prepared in Preparation Example 1 and 1.5 kg of the Hericium erinaceus mycelium powder prepared in Preparation Example 2 were mixed to prepare a Hericium erinaceus power mixture. 5 kg of the Hericium erinaceus power mixture was added to a solvent mixture of 2.5 L of ethanol and 10 L of water, and heated in a 100 L stainless container equipped with a reflux apparatus at a temperature of 90 to 98° C. for 24 hours to extract a crude extract. The crude extract was filtered with a nonwoven fabric filter, and then the solvent mixture was evaporated by vacuum distillation, thereby preparing 500 ml of an extract of a mixture of a Hericium erinaceus fruiting body and mycelium in a concentrated liquid form. The extract of the mixture of Hericium erinaceus fruiting body and mycelium was lyophilized, and the lyophilized extract was named Hericium erinaceus extract C. The Hericium erinaceus extract C was used to manufacture chewing gum.

### Example 1

Gum ingredients were put into a container for manufacturing gum. The gum ingredients are prepared by adding 40 parts by weight of the Hericium erinaceus extract A prepared in Preparation Example 3, 10 parts by weight of cordycepin, 0.5 part by weight of disodium edetate which is a stabilizer, 1 part by weight of menthol, 1 part by weight of cetylpyridinium chloride, 0.5 part by weight of a softener, 10 parts by weight of a sorbitol solution, 5 parts by weight of isomaltooligosaccharide, 5 parts by weight of xylitol, 0.5 part by weight of a favoring, 0.5 part by weight of a sweetener, and 0.5 part by weight of an edible colorant based on 100 parts by weight of the gum base. At this time, liquid ingredients were mixed with a small amount of powder ingredients before they are added to the gum base so as to allow the gum ingredients to be mixed well. The chewing gum composition was injected while maintaining the container for manufacturing gum at a temperature of 60° C. whereby chewing gum was prepared.

### Example 2

Chewing gum was prepared in the same manner as in Example 1, except that 40 parts by weight of the Hericium erinaceus extract B was added instead of the Hericium erinaceus extract A.

### Example 3

Chewing gum was prepared in the same manner as in Example 1, except that 40 parts by weight of the Hericium erinaceus extract C was added instead of the Hericium erinaceus extract A.

### Comparative Example 1

Chewing gum was prepared in a same manner as in Example 1, except that the Hericium erinaceus extract A was not added. That is, the Hericium erinaceus extract was not used at all when manufacturing chewing gum.

### Comparative Example 2

Chewing gum was prepared in the same manner as in Example 1, except that cordycepin was not added.

### Comparative Example 3

Chewing gum was prepared in the same manner as in Example 1, except that the Hericium erinaceus extract A and cordycepin were not added. That is, the Hericium erinaceus extract and cordycepin were not used at all when manufacturing chewing gum.

### <Experimental Example 1> Sensory Evaluation

The chewing gums of Examples 1 to 3 and Comparative Examples 1 to 3 were subjected to sensory evaluation. A panel was composed of 50 males and females in their 20s to 70s. The panel evaluated the chewing gums of Examples 1 to 3 and Comparative Examples 1 to 3 using a five-point scale in terms of flavor, taste and preference (5 points: excellent, 4 points: good, 3 points: normal, 2 points: bad, and 1 point: very bad).

As a result, it seemed that there was a difference in preference with respect to taste and flavor peculiar to the Hericium erinaceus extract, but it was found that there was no significant difference. In particular, it was shown that the Hericium erinaceus extract has a higher level of preference among people in their 60s or older (see Table 1).

TABLE 1

| | Flavor | Taste | Preference |
|---|---|---|---|
| Example 1 | 3.9 | 4.0 | 4.1 |
| Example 2 | 3.8 | 4.1 | 3.8 |
| Example 3 | 3.7 | 4.2 | 4.0 |
| Comparative | 3.9 | 4.0 | 3.9 |
| Example 1 | | | |
| Comparative | 4.1 | 3.9 | 4.1 |
| Example 2 | | | |
| Comparative | 4.2 | 3.8 | 4.0 |
| Example 3 | | | |

### <Experimental Example 2> Evaluation of Saliva Secretion Promoting Effect and Bad Breath Removing Effect

With respect to the chewing gums of Examples 1 to 3 and Comparative Examples 1 to 3, changes in saliva secretion before and after chewing gum were evaluated. A panel was composed of 50 males and females in their 20s to 70s. After the chewing gum was chewed for 15 minutes, a degree of salivation was compared to that before the chewing gum was chewed (5 points: significantly increased saliva secretion, 4 points: slightly increased saliva secretion, 3 points: no significant difference, 2 points: slightly decreased saliva secretion, 1 point significantly decreased saliva secretion).

Also, the bad breath removing effect of each of the chewing gums of Examples 1 to 3 and Comparative Examples 1 to 3 was evaluated by the same panel. The evaluation method is as follows. The panels chewed the chewing gum for 15 minutes, and then spit the chewing gum. After 5 minutes, the panels were allowed to place an opening portion of a container (bowl shape) with only one direction open on their nose and mouth and breath through their mouth, and then smell the inside of the container. Thereafter, a degree of bad breath was evaluated in comparison to that before the chewing gum was chewed (5 points: significantly decreased bad mouth, 4 points: slightly decreased bad mouth, 3 points: no significant difference, 2 points: slightly increased bad mouth, 1 point significantly increased bad mouth).

As a result, it was shown that the chewing gums of Examples 1 and 3 have the best saliva secretion promoting effect. In Example 2, saliva secretion was promoted to a significant degree. However, in Comparative Examples 1 and 3, saliva secretion was slightly reduced or not significantly different from that before the chewing gum is chewed. The evaluation results of bad breath removal effect also mostly corresponded to those of saliva secretion promoting effect. The chewing gums of Examples 1 and 3 had quite a good bad breath removing effect, and the chewing gum of Example 2 had the next best bad breath removing ability. It was considered that these results are also related to a phenomenon in which bad breath is suppressed when a large amount of saliva is secreted.

TABLE 2

| | Whether or not saliva | |
|---|---|---|
| | secretion is promoted | Bad breath removing effect |
| Example 1 | 4.3 | 4.2 |
| Example 2 | 4.0 | 4.1 |
| Example 3 | 4.1 | 3.9 |
| Comparative | 2.8 | 3.0 |
| Example 1 | | |
| Comparative | 4.0 | 2.8 |
| Example 2 | | |
| Comparative | 3.1 | 2.7 |
| Example 3 | | |

### INDUSTRIAL APPLICABILITY

The present invention relates to a chewing gum composition containing a gum base and a Hericium erinaceus extract. The present invention also relates to a chewing gum composition containing a gum base, a Hericium erinaceus extract and cordycepin. The chewing gum composition according to the present invention has a saliva secretion promoting effect, a bad breath inhibitory effect, and an antibacterial effect.

1. A chewing gum composition, comprising:
a gum base; and
a Hericium erinaceus extract.

2. The chewing gum composition of claim 1, wherein
the Hericium erinaceus extract comprises an ethanol extract of a fruiting body of Hericium erinaceus.

3. The chewing gum composition of claim 1, further comprising:
cordycepin.

4. The chewing gum composition of claim 3, wherein the chewing gum composition comprises 10 to 60 parts by weight of the Hericium erinaceus extract and 1 to 20 parts by weight of the cordycepin based on 100 parts by weight of the gum base.

5. The chewing gum composition of claim 1, wherein the chewing gum composition is a chewing gum composition for promoting saliva secretion.

6. The chewing gum composition of claim 1, wherein the chewing gum composition is a chewing gum composition for removing bad breath.

7. A method of preparing a chewing gum composition, comprising:
preparing a gum base;
adding a Hericium erinaceus extract to the gum base to produce a mixture; and,
forming the mixture in a shape of chewing gum.

8. The method of claim 7, wherein cordycepin is further added to the gum base together with the Hericium erinaceus extract.

9. The method of claim 7, wherein the Hericium erinaceus extract further comprises an ethanol extract of a fruiting body of Hericium erinaceus.

10. The method of claim 7, wherein the chewing gum composition is a chewing gum composition for promoting saliva secretion.
